(19) United States
(12) Patent Application Publication
(10) Pub. No.: US 2004/0265200 A1
(43) Pub. Date: Dec. 30, 2004

(54) Cleaning method of NO2 visible gas from stationary sources

(75) Inventors: Du-Soung Kim, Seoul (KR); Jihn-Koo Lee, Seosan-si (KR); Myoung-Jin Kha, Seosan-si (KR); Seung-Jae Lee, Seosan-si (KR)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Kocat Inc., Seoul (KR)

(21) Appl. No.: 10/830,405

(22) Filed: Apr. 22, 2004

(30) Foreign Application Priority Data
Apr. 24, 2003 (KR) 10-2003-0025953

(51) Int. Cl. B01D 53/56

(52) U.S. Cl. 423/235; 422/171; 422/172; 422/179; 422/109

(57) ABSTRACT

Disclosed are an apparatus and a method for treating exhaust gas. The apparatus includes a pipe (2) for providing a flow path of the exhaust gas containing nitrogen dioxide from a stationary source combustion process using gases as a fuel. One or more nozzles (4) are installed in the pipe (2), which can spray air and a reducing or an oxidizing agent to the exhaust gas flowing in the pipe (2). Additionally, a storage tank (6) is installed to store the reducing or oxidizing agent therein. Furthermore, an injection pump (8) is connected to the storage tank (6) and nozzle (4) at a position between the storage tank (6) and nozzle (4) to feed the reducing or oxidizing agent from the storage tank (6) to the nozzle (4), and an air pump (10) is connected to the nozzle (4) to feed the air into the pipe (2).

### RELATED APPLICATIONS

This application claims priority under 35 U.S.C. § 119 or 365 to Republic of Korea Application No. 10-2003-0025953, filed Apr. 24, 2003. The entire teachings of this Korean Application are incorporated herein by reference.

### TECHNICAL FIELD

Generally the present invention relates to an apparatus and a method of removing nitrogen dioxide from a stationary source combustion process. Particularly, the present invention relates to an apparatus and a method of converting nitrogen dioxide to nitrogen monoxide or nitrogen by spraying a reducing or oxidizing agent into a flow of exhaust gas containing nitrogen oxides, such as nitrogen dioxide (NO₂), generated from the stationary source combustion process.

### BACKGROUND OF THE INVENTION

As well known to those skilled in the art, compositions and concentrations of gases contained in the exhaust gas from a stationary source combustion process vary depending upon types of fuel materials. For example, when a stationary source uses solid (coal) or liquid (bunker fuel oil C etc.) fuels, sulfur and nitrogen compounds contained in the fuels are combusted to produce sulfur oxides (SOx) and nitrogen oxides (NOx).

Particularly, it is well known that nitrogen dioxide, an example of nitrogen oxides, generated from the stationary source combustion process is subject to photochemical reactions with various compounds in air to generate photochemical compounds and ozone, causing photochemical smog, thereby contaminating the environment and harming human health.

Nitrogen dioxide is known as a reddish brown color gas, and causes irritation in public when it is released into air from a chimney. The visible gas is reported to be frequently generated during a diffusion-combustion process at low power output (90 MW or lower). The amount of the visible gas in an exhaust gas generated from the process increases as the retention time of the exhaust gas in a chimney increases, or as the diameter of the chimney increases, or as the flow rate and temperature of the exhaust gas in the chimney decreases.

Sulfur oxide is usually removed by a limestone-plaster process, and nitrogen dioxide is removed by a selective catalytic reduction (SCR) process in which nitrogen dioxide is converted into nitrogen and water by a reaction with a reducing agent in the presence of a catalyst.

Ammonia is widely used as a reducing agent in the selective catalytic reduction process because of its excellent catalytic reactivity and selectivity. For example, U.S. Pat. No. 5,024,981 discloses an NH₃-SCR process for selectively removing nitrogen dioxide contained in exhaust gas by using a honeycomb-structured catalyst, an active material comprising vanadium and tungsten, which is supported by a titania carrier.

Recently, use of gaseous fuels such as a liquefied natural gas (LNG), known as a pure fuel, increases to minimize pollutants from the stationary source combustion process. As compared to coals or oils, the liquefied natural gas contains fewer nitrogen compounds, and it emits only a small amount of nitrogen oxides, below a limit of tolerance.

In the case where gaseous fuels are used, most of nitrogen oxides contained in the exhaust gas from the stationary source are generated by the oxidation of nitrogen contained in air at a high temperature. The concentration of nitrogen oxides depends on operational conditions such as load of an engine used in the combustion process.

The selective catalytic reduction process using a traditional catalyst can effectively remove nitrogen dioxide , especially a small amount of nitrogen dioxide visible gas discharged from the stationary source using gas fuels. However, there remain disadvantages of high equipment cost and pressure dissipation due to the catalyst.

The amount of a catalyst required in the selective catalytic reduction process depends on a space velocity provided by catalyst makers or engineering companies. For example, when one considers the space velocity of a commercialized NH₃-SCR process, which is 5000 to 7000 h⁻¹, and a usual flow rate of 500,000 to 1,000,000 Nm³/h of the exhaust gas from the stationary source, depending on a power generation capacity, the amount of the catalyst is 70 to 200 m³. Accordingly, the commercialized NH₃-SCR process is not efficient in terms of catalyst cost.

Additionally, in the case where the stationary source uses gaseous fuels, if a catalytic reactor is installed in a traditional system, a gas flow is disturbed due to a pressure difference before and after the catalyst, negatively affecting the combustion process before the catalytic reaction. Thus, when a catalyst is used, it is necessary to enlarge equipments to minimize the pressure difference, which renders a enormous investment cost for removing a relatively small amount of nitrogen dioxide visible gas. In addition, such equipments require larger area, causing difficulties in securing the location for the equipments.

When the stationary source uses gaseous fuels, it takes only 30 min or less for the concentration of the visible gas to reach a visible value depending on operational load of an engine. For this reason, use of a SCR process utilizing a catalyst for reducing the concentration of nitrogen dioxide within a relatively short time period is not competitive in terms of economic efficiency, causing electric-power production costs to be undesirably high.

Therefore, there is a need to develop a new technology for converting nitrogen dioxide contained in the exhaust gas from a power plant into nitrogen monoxide or nitrogen, which comprises the step of injecting a reducing or oxidizing agent into the exhaust gas through an apparatus used for treating the exhaust gas, without using additional devices.

U.S. Pat. No. 5,489,420 discloses a technology for removing nitrogen oxides by adding a reducing agent such as ammonias into a nitrogen oxides stream at 950° C. or higher. U.S. Pat. Nos. 5,443,805 and 5,536,482 discuss a process for removing nitrogen oxides by using polymers in addition to ammonias at 900 to 1200° C.

### SUMMARY OF THE INVENTION

The present invention has been made, keeping in mind the above problems in the prior art. An object of the present invention is to provide an apparatus and methods of converting nitrogen dioxide to nitrogen monoxide or nitrogen by spraying a reducing or oxidizing agent into a flow of the exhaust gas containing nitrogen oxides, such as nitrogen dioxide (NO₂), generated from a stationary source combustion process.

Another object of the present invention is to prevent the reducing or oxidizing agent from being combusted before the reducing or oxidizing agent reacts with nitrogen dioxide by installing nozzles for spraying the reducing or oxidizing agent into a flow path of the exhaust gas in a pipe and by insulating the pipe that is connected to the nozzles, through which the exhaust gas flows.

It is still another object of the present invention to allow nitrogen dioxide to easily come into contact with the reducing or oxidizing agent, which enables an improved removal efficiency of nitrogen dioxide, by spraying the reducing or oxidizing agent to the flow path of the exhaust gas in such a way that the reducing or oxidizing agent is sprayed at once through only one tube or a plurality of tubes into the exhaust gas or sprayed sequentially through the tubes into the exhaust gas.

In order to accomplish the above objects, the present invention provides an apparatus for treating the exhaust gas. The apparatus includes a pipe for providing a flow path of the exhaust gas containing nitrogen dioxide from a stationary source combustion process using gaseous fuels. One or more nozzles are installed in the pipe, which controls spraying air and/or the reducing or oxidizing agent into the exhaust gas flowing through the pipe. A storage tank is installed in the apparatus to store the reducing or oxidizing agent therein. An injection pump is connected to the storage tank and the nozzle at a position between the storage tank and the nozzle. The injection pump is used for feeding the reducing or oxidizing agent from the storage tank to the nozzle. An air pump is connected to the nozzle to feed air into the pipe.

In another point of view, the present invention provides a method for treating the exhaust gas, which includes the steps of feeding the exhaust gases containing nitrogen dioxide from a stationary source combustion process that uses gaseous fuels into the pipe of the apparatus at 200 to 700° C. and spraying the reducing or oxidizing agent into the exhaust gas flowing through the pipe.

The present invention defines the exhaust gas as that emitted from the stationary source combustion process using gaseous fuels, which contains a lower content of nitrogen oxides such as nitrogen dioxide than exhaust gas from a stationary source combustion process using coals and oils as a fuel.

The reducing or oxidizing agent is sprayed in conjunction with air from the nozzles into the exhaust gas, which can reduce nitrogen dioxide contained in the exhaust gas to nitrogen monoxide or nitrogen. A molar ratio of the reducing or oxidizing agent to nitrogen oxides contained in the exhaust gas is preferably at least 0.1 or higher.

The reducing agent can be any substance which can reduce nitrogen dioxide to nitrogen monoxide. Examples of the reducing agent include ammonias such as ammonia, ammonia water, urea and hydrocarbons such as unsaturated hydrocarbon and heterogeneous hydrocarbon. Ammonias and hydrocarbons can be used together in the invention. Among these substances, ammonia water is mostly preferred.

The oxidizing agent can be any substance which can oxidize nitrogen dioxide. Examples of the oxidizing agent include hydrogen peroxide (H₂O₂) and ozone (O₃). Hydrogen peroxide is mostly preferred.

In the present application, air enables the reducing or oxidizing agent to be widely sprayed from the nozzles to the exhaust gas. Any gas other than air can also be used as long as it is inert and does not react with the reducing or oxidizing agent. Air is preferred because of its relatively low price and ease in obtaining it.

The reducing or oxidizing agent according to the present invention may be sprayed into the exhaust gases without being mixed with air. However, if the reducing or oxidizing agent is sprayed through the nozzles into the exhaust gas without being mixed with air, the reducing or oxidizing agent may not be sufficiently sprayed into the whole exhaust gas.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 schematically illustrates an apparatus for treating an exhaust gas according to the embodiment of the present invention;

FIG. 2 schematically illustrates another aspect of an apparatus for treating an exhaust gas according to the embodiment of the present invention;

FIG. 3 is a graph showing conversion efficiency of nitrogen dioxide using ammonia as a reducing agent according to the present invention;

FIG. 4 is a graph showing conversion efficiency of nitrogen dioxide using hydrocarbons as the reducing agent according to the present invention;

FIG. 5 is a graph showing conversion efficiency of nitrogen dioxide depending on a molar ratio of ethanol to nitrogen dioxide according to the present invention;

FIG. 6 is a graph showing conversion efficiency of nitrogen dioxide using hydrogen peroxide as an oxidizing agent according to Example 8 of the present invention; and

FIG. 7 is a graph showing conversion efficiency of nitrogen dioxide using ethanol as the reducing agent, depending upon whether or not a nozzle of the present invention is insulated.

### DETAILED DESCRIPTION OF THE INVENTION

A description of preferred embodiments of the invention follows.

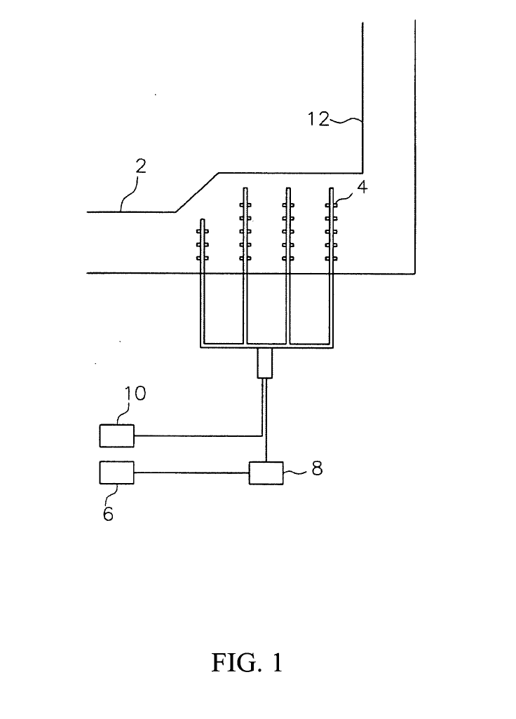

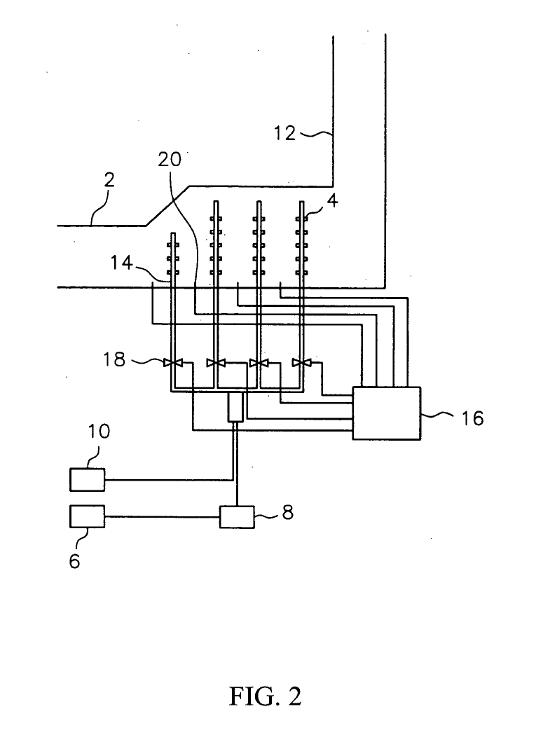

FIG. 1 schematically illustrates an apparatus for treating an exhaust gas according to an embodiment of the present invention, and FIG. 2 schematically illustrates another aspect of an apparatus for treating an exhaust gas according to an embodiment of the present invention.

With reference to FIGS. 1 and 2, the apparatus according to the present invention includes pipe 2 acting as a flow path of exhaust gas containing nitrogen dioxide, generated from a stationary source combustion process using gases as a fuel; one or more nozzles 4 installed in pipe 2 to spray the reducing or oxidizing agent to the exhaust gas flowing in pipe 2; storage tank 6 for storing the reducing or oxidizing agent which will be sprayed out by nozzles 4; injection pump 8 installed between storage tank 6 and nozzles 4 to transport the reducing agent and/or oxidizing agent from storage tank 6 to nozzles 4; air pump 10 connected to nozzles 4 to feed highly compressed air into pipe 2; and chimney 12 through which the treated exhaust gas is discharged.

Pipe 2 according to the present invention is connected to the stationary source at a first end to receive the exhaust gases containing nitrogen dioxide from the stationary source combustion process using gaseous fuels, and is communicated with chimney 12 at a second end in order to discharge the treated exhaust gas.

Nozzles 4 according to the present invention are installed in pipe 2 to spray air and the reducing or oxidizing agent into the exhaust gas containing nitrogen dioxide passing through pipe 2. Nozzles 4 may be installed in any manner in the pipe 2 as long as air and the reducing or oxidizing agent are desirably sprayed into the exhaust gas. Preferably, nozzles 4 may be installed in pipe 2 in a single- or multi-stage injection manner so as to easily spray air and the reducing or oxidizing agent into the exhaust gas containing nitrogen dioxide passing through pipe 2.

According to the single-stage manner, tube 14 is structured so that a plurality of holes is formed on a surface of tube 14, and nozzles 4 are connected to the holes. In the case of the multi-stage manner, two or more tubes, as described above, are installed in pipe 2.

The apparatus according to the present invention may further comprise valves 18 installed at tubes 14 to control a flow rate of a fluid passing through each of tubes 14; one or more temperature sensors 20 installed in pipe 2 to sense a temperature of the exhaust gas flowing in pipe 2; and control unit 16 connected to valves 18 and temperature sensors 20 to control valves 18 based on temperature data from temperature sensors 20.

Temperature sensors 20 may be installed at any positions in pipe 2 so long as the temperature of the exhaust gas flowing in pipe 2 is easily measured.

Nozzles 4 and an outer surface of each of tubes 14 connected to nozzles 4 may be insulated by an insulating material so as to prevent the exhaust gas at 200 to 700° C. from combusting the reducing or oxidizing agent. Additionally, cool air may be fed through nozzles 4 and/or tubes 14, to effectively further prevent the reducing or oxidizing agent passing through nozzles 4 and tubes 14 from being combusted by the high temperature of the exhaust gas.

As described above, nozzles 4 that spray air and the reducing or oxidizing agent are connected to air pump 10 that compresses air supplied from the atmosphere. Nozzles 4 can also be sequentially connected to injection pump 8 that feeds the reducing or oxidizing agent to nozzles 4 and to storage tank 6 that stores the reducing or oxidizing agent therein. In this regard, injection pump 8 acting as a power source functions to feed the reducing or oxidizing agent from storage tank 6 to nozzles 4.

Air pump 10 functions to supply compressed air in conjunction with the reducing or oxidizing agent into nozzles 4, injecting the reducing or oxidizing agent at high pressure into the pipe so that the exhaust gas containing nitrogen dioxide can be readily mixed with the reducing or oxidizing agent.

Hereinafter, a description will be given of the operation of the apparatus according to the present invention.

The exhaust gas containing nitrogen dioxide from the stationary source combustion process using gaseous fuels is fed into pipe 2 through nozzles 4. The reducing or oxidizing agent stored in storage tank 6 is then fed into nozzles 4 by injection pump 8, and air is simultaneously fed into nozzles 4 by air pump 10. Subsequently, air and the reducing or oxidizing agent that are fed into nozzles 4 positioned in pipe 2 are sprayed into the exhaust gas containing nitrogen dioxide passing through pipe 2 to reduce nitrogen dioxide to nitrogen monoxide, or to convert nitrogen dioxide to nitrogen. The treated exhaust gas is discharged through chimney 12 which communicates with the rear end of pipe 2.

As described above, compressed air is fed by air pump 10 in conjunction with the reducing or oxidizing agent into nozzles 4, spraying the reducing or oxidizing agent at high pressure into the exhaust gas so that the exhaust gas containing nitrogen dioxide can be readily mixed with the reducing or oxidizing agent.

The apparatus for treating the exhaust gas according to the present invention may effectively treat the exhaust gas using control unit 16 which controls valves 18 based on temperature data from temperature sensors 20.

As described above, the apparatus is structured with one or more tubes 14 that include a plurality of nozzles 4 installed in pipe 2. Each of tubes 14 is connected to injection pump 8 and air pump 10, and at least one temperature sensor 20 is installed in pipe 2.

In this regard, valves 18 are installed at tubes 14, and valves 18 and temperature sensors 20 are connected to control unit 16.

When the exhaust gas containing nitrogen dioxide is discharged from the stationary source combustion process using gaseous fuels, the exhaust gas containing nitrogen dioxide is fed into pipe 2 through tubes 14, each of which includes a plurality of nozzles 4.

The temperature of the exhaust gas flowing in pipe 2 is measured by temperature sensors 20 installed in pipe 2, and the measured temperature data is transmitted to control unit 16. Based on the temperature data from temperature sensors 20, control unit 16 opens the valves 18 of any tubes among tubes 14 when the nozzles 4 of the tubes have a suitable temperature range, for example, from 200 to 700° C., to convert or reduce nitrogen dioxide, while keeping the valves 18 of other remaining tubes 14 closed.

The reducing or oxidizing agent stored in storage tank 6 is then fed into tube 14 by injection pump 8, where valve 18 is opened, and atmospheric air is simultaneously fed into tube 14 by air pump 10, where valve 18 is opened. Subsequently, air and the reducing or oxidizing agent fed into tubes 14 where valve 18 is opened are sprayed through nozzles 4 of tube 14 into the exhaust gas containing nitrogen dioxide flowing in pipe 2. This process can remove nitrogen dioxide from the exhaust gas by reducing nitrogen dioxide into nitrogen monoxide or converting nitrogen dioxide into nitrogen and by discharging the treated exhaust gas through chimney 12 installed at the rear end of pipe 2. Compressed air by air pump 10 can be fed in conjunction with the reducing or oxidizing agent into nozzles 4 to contribute to spraying the reducing or oxidizing agent at high pressure into the exhaust gas so that the exhaust gas containing nitrogen dioxide is easily mixed with the reducing or oxidizing agent.

A better understanding of the present invention may be obtained through the following examples which are set forth to illustrate, but are not to be construed to limit the present invention.

### EXAMPLE 1

### Removal Activity of Nitrogen Dioxide Using Ammonia as a Reducing Agent

As in FIG. 1, a rectangular pipe made of SUS 304 (height 15 cm, width 15 cm, and length 100 cm) was provided, and four tubes were installed in the pipe with a plurality of nozzles [TN050-SRW, Total nozzle Co., Korea] with those tubes spaced apart from each other at intervals of 20 cm.

Ammonia water acting as the reducing agent [Doosan Co., Korea] was charged into a storage tank and the storage tank was connected to an injection pump [M930, Younglin Co., Korea] that was connected to the tubes including the nozzles.

An air pump [HP 2.5, Air bank compressor Co., Korea] was then connected to the tubes including the nozzles to feed air into the pipe.

Subsequently, influx gas having the similar composition to exhaust gas from a combustion process using gases as a fuel was fed into the SUS 304 rectangular pipe. The composition of the influx gas was described in Table 1, below.

TABLE 1
Composition of the influx gas

| Components | NO | NO₂ | CO | O₂ | H₂O | N₂ |
|---|---|---|---|---|---|---|
| | 60 ppm | 50 ppm | 170 ppm | 14% | 6% | Balance |

Air and ammonia water stored in the storage tank were fed to the nozzles by the air pump and injection pump at the same time while the influx gas passed through the pipe.

At this time, the temperature in the pipe was maintained at 500 to 700° C. using an electric furnace [Gibo Co., Korea], and was measured using a K-type thermocouple. A molar ratio of ammonia to nitrogen dioxide was 2, and a contact time between ammonia water sprayed from the nozzles and the exhaust gas passing through the pipe was 0.731 seconds.

Furthermore, the exhaust gas was analyzed by a portable NOx analyzer [MK II, Eurotron, Italy] before and after the reaction of nitrogen dioxide with ammonia water, and conversion efficiency of nitrogen dioxide was calculated by the following Equation 1.

$$\begin{matrix}{NO}_{2} convers . ( \% ) = \\ [ \frac{{NO}_{2 } concen . before reaction - {NO}_{2} concen . after reaction}{{NO}_{2} concen . before reaction} \times 100 ] & Equation 1\end{matrix}$$

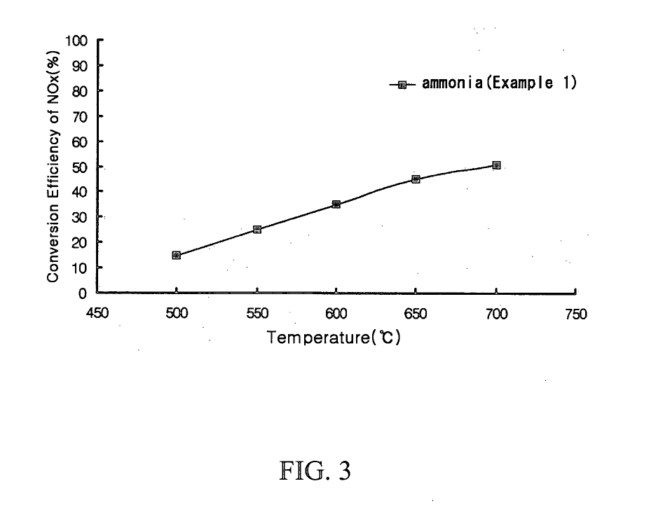

The results were plotted in FIG. 3.

### EXAMPLE 2

The procedure of example 1 was repeated except that ethanol was used as a reducing agent instead of ammonia water and a molar ratio of ethanol to nitrogen dioxide was 2.

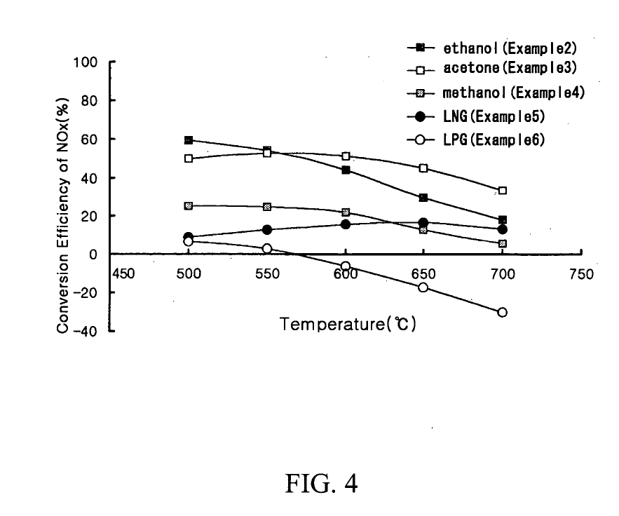

The results were plotted in FIG. 4.

### EXAMPLE 3

The procedure of example 1 was repeated except that acetone was used as a reducing agent instead of ammonia water and a molar ratio of acetone to nitrogen dioxide was 2.

The results were plotted in FIG. 4.

### EXAMPLE 4

The procedure of example 1 was repeated except that methanol was used as a reducing agent instead of ammonia water and a molar ratio of methanol to nitrogen dioxide was 2.

The results were plotted in FIG. 4.

### EXAMPLE 5

The procedure of example 1 was repeated except that LNG was used as a reducing agent instead of ammonia water and a molar ratio of LNG to nitrogen dioxide was 2.

The results were plotted in FIG. 4.

### EXAMPLE 6

The procedure of example 1 was repeated except that LPG was used as a reducing agent instead of ammonia water and a molar ratio of LPG to nitrogen dioxide was 2.

The results were plotted in FIG. 4.

### EXAMPLE 7

The procedure of example 1 was repeated except that ethanol was used as a reducing agent instead of ammonia water and removal activity of nitrogen dioxide was measured while a molar ratio of ethanol to nitrogen dioxide ranging from 1 to 2.

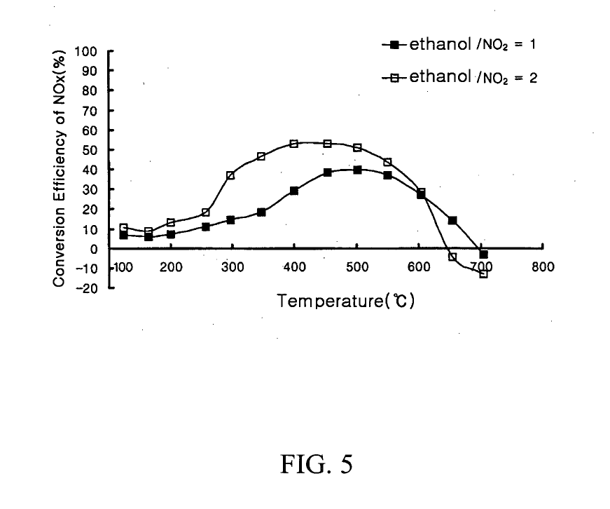

The results were plotted in FIG. 5.

### EXAMPLE 8

The procedure of example 1 was repeated except that hydrogen peroxide was used as an oxidizing agent instead of ammonia water acting as a reducing agent and a molar ratio of hydrogen peroxide to nitrogen dioxide was 1.

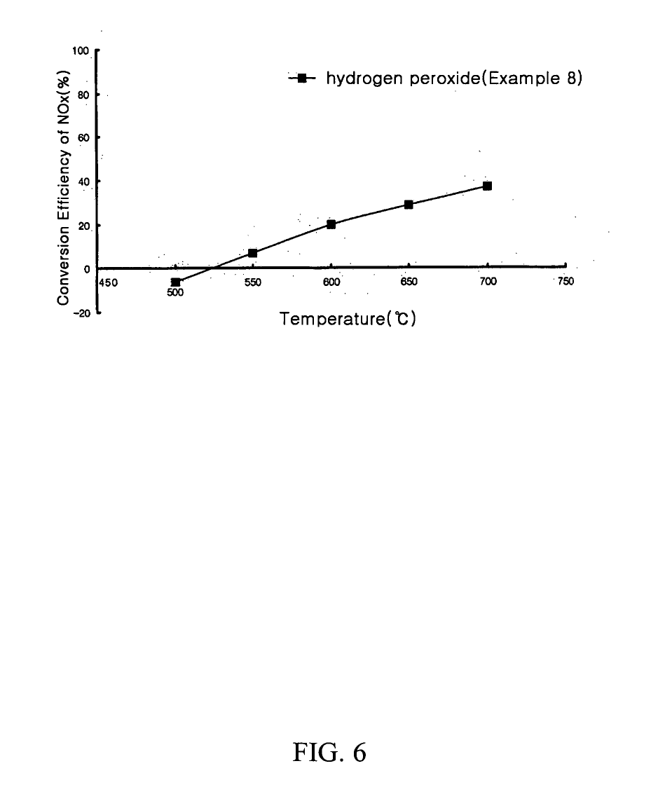

The results were plotted in FIG. 6.

### EXAMPLE 9

The apparatus according to example 1 was installed in a real LNG power plant in the 110 MW range [West-Incheon steam power plant, Korea], to measure the differences of removal activity of nitrogen dioxide depending on whether the nozzles were insulated or not. The apparatus used ethanol as a reducing agent instead of ammonia water. The molar ratio of ethanol to nitrogen dioxide was 1.

The removal activity of nitrogen dioxide was tested while the nozzles were not insulated at the beginning of the test. After this test the nozzles and the tubes were insulated and the removal activity of nitrogen dioxide was again tested.

The results were described in Table 2.

### EXAMPLE 10

The procedure of example 9 was repeated except that a molar ratio of ethanol to nitrogen dioxide was 3.

The results were described in Table 2.

### EXAMPLE 11

The procedure of example 9 was repeated except that a molar ratio of ethanol to nitrogen dioxide was 5.

The results were described in Table 2.

TABLE 2

| Ex. | Ethanol/NO₂ molar ratio | ¹Before insulation | ²After insulation |
|---|---|---|---|
| 9 | 1 | 25.9 | 37.8 |
| 10 | 3 | 54.3 | 66.2 |
| 11 | 5 | 82.6 | 94.8 |

¹Before insulation: removal activity of NO₂ before insulation (%)
²After insulation: removal activity of NO₂ after insulation (%)

Removal activity of nitrogen dioxide increased after the nozzles and tubes were insulated. The reason for these data was that when a temperature of the exhaust gas was 500 to 650° C. according to an increase of an engine load, ethanol was partially oxidized even before reaching the nozzles, so reactivity of ethanol to nitrogen dioxide was reduced. Therefore, oxidation of ethanol was suppressed by insulating the nozzles and tubes using an insulating material, thereby increasing removal activity of nitrogen dioxide.

### EXAMPLE 12

Removal activity of NO₂ was tested in an LNG power plant in the 110 MW range [West-Incheon steam power plant, Korea] under test conditions that the molar ratio of ethanol to nitrogen dioxide was 3 and the temperature range of the exhaust gas ranging from 350 to 650° C.

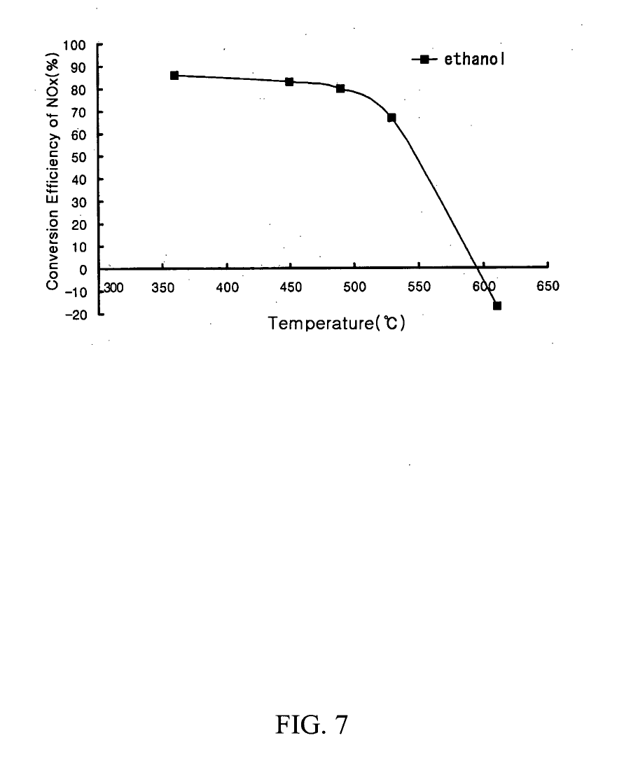

The results were plotted in FIG. 7.

From FIG. 7, it can be seen that when the temperature of the exhaust gas was increased to 500° C. or higher, ethanol as a reducing agent was oxidized and removal activity of nitrogen dioxide was greatly reduced.

### Industrial Applicability

As described above, the present invention provides an apparatus for economically treating exhaust gas without high initial installation cost or high operational cost needed in a conventional selective catalytic reduction process, in which a reducing agent or an oxidizing agent is sprayed into the exhaust gas containing nitrogen dioxide from a stationary source combustion process to remove nitrogen dioxide by reducing nitrogen dioxide to nitrogen monoxide or to convert nitrogen dioxide to nitrogen.

The present invention has been described in an illustrative manner, and it is to be understood that the terminology is intended to be in the nature of description rather than of limitation. Many modifications and variations of the present invention are possible in light of the above teachings. Therefore, it is to be understood that within the scope of the appended claims, the invention may be practiced otherwise than as specifically described.

While this invention has been particularly shown and described with references to preferred embodiments thereof, it will be understood by those skilled in the art that various changes in form and details may be made therein without departing from the scope of the invention encompassed by the appended claims.

What is claimed is:

1. An apparatus for removing nitrogen dioxide contained in an exhaust gas from a stationary source combustion process, comprising:
a pipe for providing a flow path of the exhaust gas;
one or more nozzles installed in the pipe, wherein the nozzles spray air and/or a reducing or oxidizing agent to the exhaust gas flowing through the pipe;
a storage tank used for storing the reducing or oxidizing agent;
an injection pump installed between the storage tank and the nozzles, wherein the injection pump feeds the reducing or oxidizing agent from the storage tank to the nozzles; and
an air pump connected to the nozzles to feed air into the pipe.

2. The apparatus of claim 1 further comprising one or more tubes installed in the pipe in a single- or multi-stage injection manner, wherein the nozzles are connected to the tubes, and air and the reducing or oxidizing agent are sprayed to the exhaust gas through the tubes.

3. The apparatus of claim 2 further comprising a valve installed at each of the tubes, which controls the flow rate of a fluid passing through the tubes; at least one temperature sensor installed in the pipe, which senses the temperature of the exhaust gas flowing through the pipe; and a control unit connected to the valve and the temperature sensor to control the valve based on temperature data output from the temperature sensor.

4. The apparatus of claim 3, wherein (a) the nozzle, the tube, or the nozzle and tube are surrounded by an insulating material shielding the nozzle, the tube, or the nozzle and tube from heat emitted from a high temperature exhaust gas, shielding the nozzle, the tube, or the nozzle and tube from heat emitted from a high temperature exhaust gas; or wherein (b) the nozzle, the tube, or the nozzle and tube are surrounded by the insulating material and cool air is flowing through the nozzle, the tube, or the nozzle and tube to shield the nozzle, the tube, or the nozzle and tube from heat emitted from a high temperature exhaust gas.

5. The apparatus of claim 2, wherein (a) the nozzle, the tube, or the nozzle and tube are surrounded by an insulating material shielding the nozzle, the tube, or the nozzle and tube from heat emitted from a high temperature exhaust gas, shielding the nozzle, the tube, or the nozzle and tube from heat emitted from a high temperature exhaust gas; or wherein (b) the nozzle, the tube, or the nozzle and tube are surrounded by the insulating material and cool air is flowing through the nozzle, the tube, or the nozzle and tube to shield the nozzle, the tube, or the nozzle and tube from heat emitted from a high temperature exhaust gas.

6. The apparatus of claim 1, wherein (a) the nozzle, the tube, or the nozzle and tube are surrounded by an insulating material shielding the nozzle, the tube, or the nozzle and tube from heat emitted from a high temperature exhaust gas, shielding the nozzle, the tube, or the nozzle and tube from heat emitted from a high temperature exhaust gas; or wherein (b) the nozzle, the tube, or the nozzle and tube are surrounded by the insulating material and cool air is flowing through the nozzle, the tube, or the nozzle and tube to shield the nozzle, the tube, or the nozzle and tube from heat emitted from a high temperature exhaust gas.

7. The apparatus of claim 1, wherein the oxidizing agent is selected from the group consisting of hydrogen peroxide, ozone, and a mixture thereof.

8. The apparatus of claim 2, wherein the oxidizing agent is selected from the group consisting of hydrogen peroxide, ozone, and a mixture thereof.

9. The apparatus of claim 3, wherein the oxidizing agent is selected from the group consisting of hydrogen peroxide, ozone, and a mixture thereof.

10. The apparatus of claim 1, wherein the reducing agent is ammonias or hydrocarbons.

11. The apparatus of claim 2, wherein the reducing agent is ammonias or hydrocarbons.

12. The apparatus of claim 3, wherein the reducing agent is ammonias or hydrocarbons.

13. The apparatus of claim 10, wherein the ammonias are selected from the group consisting of ammonia gas, ammonia water, urea, and a mixture thereof.

14. The apparatus of claim 10, wherein the hydrocarbons are selected from the group consisting of unsaturated hydrocarbon, heterogeneous hydrocarbon, and a mixture thereof.

15. A method of treating an exhaust gas, comprising the steps of:
feeding the exhaust gas containing nitrogen dioxide into a pipe providing a flow path of the exhaust gas; and
spraying a reducing or an oxidizing agent to the exhaust gas containing nitrogen dioxide flowing in the pipe.

16. A method of treating exhaust gas as claimed in claim 15, wherein air and the reducing or oxidizing agent are sprayed to the exhaust gas through one or more tubes installed in the pipe in a single- or multi-stage injection manner, where one or more nozzles are connected to the tubes.

17. A method of treating exhaust gas as claimed in claim 16, further comprising the steps of:
controlling the flow rate of a fluid passing through the tubes by a valve installed at each of the tubes;
sensing the temperature of the exhaust gas flowing through the pipe by at least one temperature sensor installed in the pipe; and
controlling the valve based on temperature data output from the temperature sensor by a control unit connected to the valve and the temperature sensor.

18. A method of treating exhaust gas as claimed in claim 16 further comprising the step of surrounding any combination of the nozzles and tubes by an insulating material to shield the same from heat emitted from the exhaust gas.

19. A method of treating exhaust gas as claimed in claim 15, wherein the oxidizing agent is selected from the group consisting of hydrogen peroxide, ozone and a mixture thereof; and the reducing agent is ammonias or hydrocarbons.

20. A method of treating exhaust gas as claimed in claim 19, wherein the ammonias are selected from the group consisting of ammonia gas, ammonia water, urea, and a mixture thereof; and the hydrocarbons are selected from the group consisting of unsaturated hydrocarbon, heterogeneous hydrocarbon, and a mixture thereof.
